(19) United States
(12) Patent Application Publication
(10) Pub. No.: US 2010/0332467 A1
(43) Pub. Date: Dec. 30, 2010

(54) DISPLAY PROCESSING APPARATUS, DISPLAY PROCESSING METHOD, AND COMPUTER PROGRAM PRODUCT

(76) Inventors: Yoshihisa Kizuka, Oume-shi (JP); Hitoshi Saijo, Kunitachi-shi (JP); Mieko Onodera, Kawasaki-shi (JP); Sayoko Tanaka, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/769,455

(22) Filed: Apr. 28, 2010

(30) Foreign Application Priority Data
Jun. 26, 2009 (JP) 2009-152151

(51) Int. Cl. G06F 17/30

(52) U.S. Cl. 707/723; 707/E17.014

(57) ABSTRACT

According to one embodiment, an display processing apparatus includes an operation receiver, a view information acquiring module, a correlation calculator, a display information generator, and a display controller. The operation receiver receives operation to select key content. The view information acquiring module acquires view correlation information. The correlation calculator calculates the correlation of each of second contents with the key content based on the similarity to the key content and the view correlation information. The display information generator generates first display information of the key content and second display information of the second contents. The display controller displays list information including the first display information and pieces of the second display information. The pieces of the second display information are arranged around the first display information such that second display information of second content with higher correlation with the key content is closer to the first display information.

### CROSS-REFERENCE TO RELATED APPLICATIONS

This application is based upon and claims the benefit of priority from Japanese Patent Application No. 2009-152151, filed Jun. 26, 2009, the entire contents of which are incorporated herein by reference.

### BACKGROUND

1. Field

One embodiment of the invention relates to a display processing apparatus, a display processing method, and a computer program product.

2. Description of the Related Art

In recent years, with increased capability of AV equipment for storing contents and improved seamless accessibility of contents between equipment, let alone within the same equipment, or on a network, there has been a proliferation in the number of contents accessible to users. Accordingly, for example, Japanese Patent Application Publication (KOKAI) No. 2001-292383 discloses a conventional receiving device that allows users to select and view such contents.

With the conventional receiving device, in response to user selection of content from a list of contents, the content desired by the user is displayed. When the content selected by the user is stored in the device, the content is read and displayed on its data display module. On the other hand, when the content is present outside the device, the content is received from the outside and displayed on the data display module.

Besides, a recent increase in the capacity of storage media such as a hard disk drive (HDD) provided to AV equipment increases contents from which the user can select a desired one to view. If what is to be displayed includes video audio data (contents) on a network, then, the number of contents to be searched for further increases. Thus, there is a need for a technology that facilitates the retrieval of content desired by the user from various types of contents.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a display processing apparatus according to an embodiment of the invention;

FIG. 2 is an exemplary schematic diagram for explaining a view information management table in the embodiment;

FIG. 3 is an exemplary schematic diagram of metadata when a television (TV) program is content in the embodiment;

FIG. 4A is an exemplary schematic diagram of display information in the embodiment;

FIG. 4B is another exemplary schematic diagram of display information in the embodiment;

FIG. 5A is an exemplary schematic diagram for explaining the operation of displaying the display information in the embodiment;

FIG. 5B is another exemplary schematic diagram for explaining the operation of displaying the display information in the embodiment;

FIG. 6 is an exemplary schematic diagram for explaining how to display the display information in the embodiment;

FIG. 7 is another exemplary schematic diagram for explaining how to display the display information in the embodiment;

FIG. 8 is still another exemplary schematic diagram for explaining how to display the display information in the embodiment;

FIG. 9 is still another exemplary schematic diagram for explaining how to display the display information in the embodiment;

FIG. 10 is an exemplary schematic diagram of list information in which are arranged display information of key content and that of other contents in the embodiment; and

FIG. 11 is an exemplary flowchart of the process of displaying the display information in the embodiment.

### DETAILED DESCRIPTION

Various embodiments according to the invention will be described hereinafter with reference to the accompanying drawings. In general, according to one embodiment of the invention, a display processing apparatus comprises an operation receiver, a view information acquiring module, a correlation calculator, a display information generator, and a display controller. The operation receiver is configured to receive operation to select key content in a first type as a search key. The view information acquiring module is configured to acquire view correlation information indicating content view tendency. The correlation calculator is configured to calculate the correlation of each of second contents with the key content based on the similarity to the key content and the view correlation information. The second contents are of a plurality of types including a second type different from the first type. The display information generator is configured to generate first display information of the key content and second display information of the second contents. The display controller is configured to display list information including the first display information at a predetermined position and pieces of the second display information around the predetermined position. The pieces of the second display information are arranged such that second display information of second content with higher correlation with the key content is closer to the first display information.

According to another embodiment of the invention, there is provided a display processing method applied to a display processing apparatus comprising a controller and a storage module. The display processing method performed by the controller comprises: an operation receiver receiving operation to select key content in a first type as a search key; a view information acquiring module acquiring view correlation information indicating content view tendency; a correlation calculator calculating correlation of each of second contents with the key content based on similarity to the key content and the view correlation information, the second contents being of a plurality of types including a second type different from the first type; a display information generator generating first display information of the key content and second display information of the second contents; and a display controller displaying list information including the first display information at a predetermined position and pieces of the second display information around the predetermined position, the pieces of the second display information being arranged such that second display information of second content with higher correlation with the key content is closer to the first display information.

According to still another embodiment of the invention, a computer program product comprises a computer usable medium having computer readable program codes embodied in the medium that, when executed, causes a computer to implement the above display processing apparatus.

Although a display processing apparatus of the embodiments is described below as being applied to a personal computer provided with a television (TV), this is by way of example only and is not to be construed to be limiting. The display processing apparatus may be any display device capable of displaying video or the like. Briefly, in the following embodiments, when a user searches for or retrieves a key content as a search key and content related to the key content from a plurality of contents, the display processing apparatus displays the key content with contents related to the key content in response to user selection of the key content.

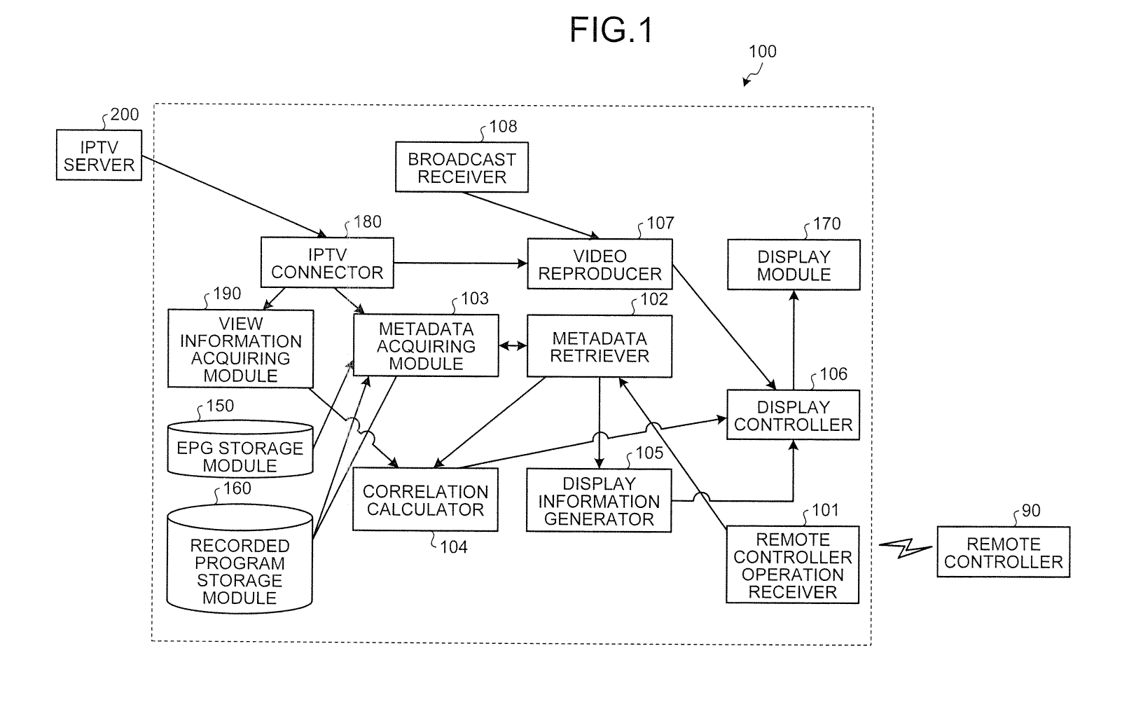

A description will be given of the functional configuration of a display processing apparatus 100 according to an embodiment of the invention. FIG. 1 is a block diagram of the display processing apparatus 100 of the embodiment. As illustrated in FIG. 1, the display processing apparatus 100 comprises an electronic program guide (EPG) storage module 150, a recorded program storage module 160, a display module 170, a broadcast receiver 108, and an Internet protocol television (IPTV) connector 180. The display processing apparatus 100 is connected to an IPTV server 200 via a network. Although not illustrated, the display processing apparatus 100 further comprises a processor, such as an application-specific integrated circuit (ASIC) or a central processing unit (CPU), and a storage device. Examples of the storage device include a read only memory (ROM) that stores a predetermined computer program for controlling the display processing apparatus 100 and a random access memory (RAM) that provides a work area for the processor. The cooperation of the processor and the computer program stored in the storage device implements functional modules including the EPG storage module 150, the recorded program storage module 160, a remote controller operation receiver 101, a metadata retriever 102, a metadata acquiring module 103, a view information acquiring module 190, a correlation calculator 104, a display information generator 105, a display controller 106, and a video reproducer 107.

The IPTV server 200 provides a service of distributing video such as TV programs and movies using IP. In response to a request from the display processing apparatus 100, the IPTV server 200 delivers thereto content such as video and metadata of the content.

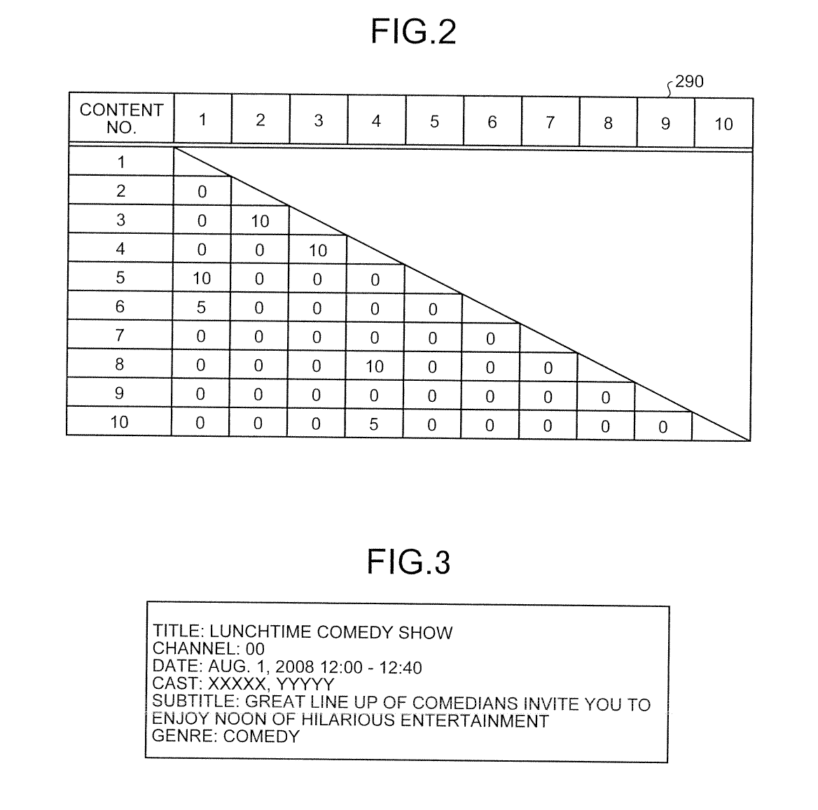

FIG. 2 is a schematic diagram for explaining a view information management table 290. The IPTV server 200 also corrects information on contents viewed on the display processing apparatus 100, and statistically manages view tendency related to a plurality of contents as view correlation information using, for example, the view information management table 290.

The term “view correlation information” as used herein refers to the correlation between contents indicating that, when a user views certain content, the degree at which the user is likely to view another content. The view correlation information reflects the view tendency of the user.

An example will be described in which the view correlation information indicates that the number of users who view a key content and further view another content or the number of times each content is viewed.

In the view information management table 290 illustrated in FIG. 2, a total of 10 users view content No. 1 and also content No. 5, and the view correlation information of the content No. 5 indicates 10 with respect to the content No. 1. Meanwhile, five users view content No. 1 and also content No. 6, and the view correlation information of the content No. 6 indicates 5 with respect to the content No. 1. In this manner, the view tendency is statistically managed such that the content No. 5 has a higher degree of view correlation with the content No. 1 compared to the content No. 6.

The view correlation information may indicate the ratio of the number of users who view, for example, content No. 2 to the number of users who view the content No. 1, or may be the ratio weighted by a constant or a function.

Besides, in response to a request from the display processing apparatus 100, the IPTV server 200 delivers the view correlation information related to content that the IPTV server 200 has provided to the display processing apparatus 100.

Thus, the display processing apparatus 100 of the embodiment uses the view correlation information received from the IPTV server 200 to calculate the correlation between contents.

The IPTV connector 180 is an interface that connects between the display processing apparatus 100 and the IPTV server 200.

The view information acquiring module 190 acquires view information. More specifically, the view information acquiring module 190 acquires through the IPTV connector 180 the view correlation information of other contents with respect to a key content corrected by the IPTV server 200. The view information acquiring module 190 then output the view correlation information to the correlation calculator 104.

The EPG storage module 150 is a storage medium such as a hard disk drive (HDD) or a memory for storing an electronic program guide obtained from an external server that manages and distributes the electronic program guide or from TV broadcast. More specifically, the EPG storage module 150 obtains via a communication module (not illustrated) an electronic program guide for TV, cable television (CATV), communications satellite (CS) broadcasting, broadcasting satellite (BS) broadcasting, and the like from a service provider server connected through a network such as the Internet, or receives via an antenna or a cable (not illustrated) an electronic program guide broadcasted by TV broadcast. Thus, the EPG storage module 150 stores the electronic program guide. It is assumed herein that the electronic program guide contains information on programs to be broadcasted during a period from the present time to a certain time in the future (e.g., after one week). Information on programs to be stored in the EPG storage module 150 is periodically updated, and information that has already been stored may also be updated.

The recorded program storage module 160 is a storage medium such as HDD or memory for storing content such as video. For example, if the display processing apparatus 100 is TV with HDD, the recorded program storage module 160 stores video of a recorded TV program as the content. Examples of the content include video in a digital versatile disk (DVD) and video captured by a video camera.

The recorded program storage module 160 also stores metadata related to the content in association therewith. The term “metadata” as used herein refers to a set of information indicating unique characteristics of the content. The unique characteristics include the title of the content and the broadcast date and time of the content. For example, if the content is a TV program, the metadata indicates information (program information) on the TV program such as the title, the channel/broadcast date and time, the cast, the brief description (subtitle), and the genre. This metadata is provided to the recorded program storage module 160 with the content and stored therein.

FIG. 3 illustrates the metadata when a TV program is the content. The metadata illustrated in FIG. 3 represents information related to the content of a recorded TV program. The information, such as the title of the TV program “Lunchtime Comedy Show”, the channel “00”, the broadcast date and time “Aug. 1, 2008, 12:00-12:40”, the cast “xxxxx, yyyyy”, the subtitle “Great line up of comedians invite you to enjoy a noon of hilarious entertainment”, and the genre “comedy”, is stored as metadata.

Although an example is described above in which the metadata is provided as being preset, this is by way of example and not of limitation. The recorded program storage module 160 may receive information provided by a user thorough an input device such as a remote controller 90 or a keyboard of the PC, and store it as metadata in association with the content.

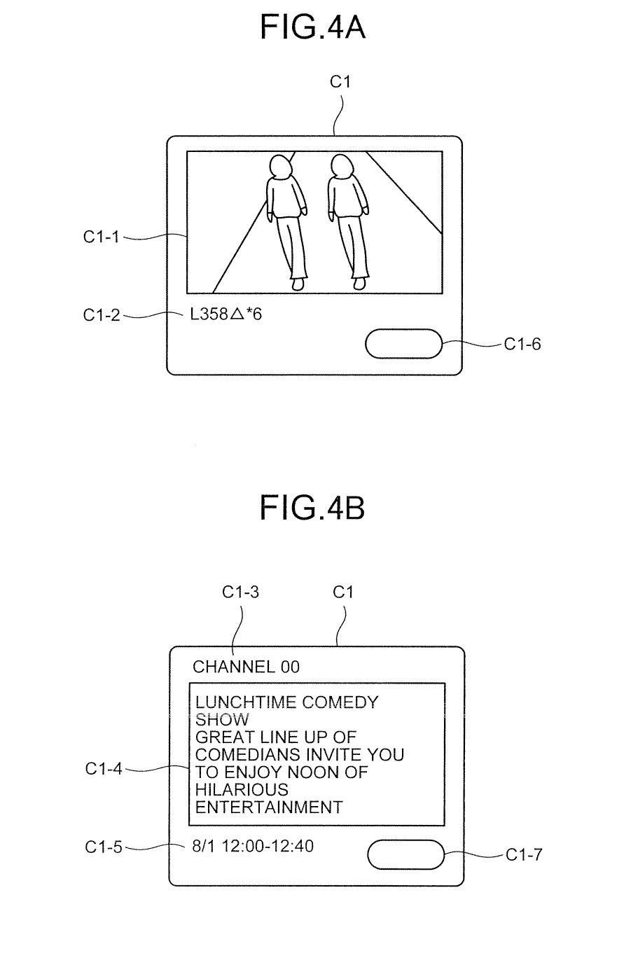

The display module 170 includes, for example, a liquid crystal display (LCD) for displaying text and an image, and displays content of a received TV program, stored content, an electronic program guide, and the like. The display module 170 also displays display information representing the details of the content generated by the display information generator 105, which will be described later, to allow a user to retrieve content (see FIGS. 4A and 4B).

The broadcast receiver 108 receives the content of video (TV program) broadcasted by TV broadcast through an antenna or a cable (not illustrated).

The video reproducer 107 acquires the content of video that a user desires to reproduce. Examples of the content include the content of a TV program, etc. received by the broadcast receiver 108, the content of video acquired from the IPTV server 200 through the IPTV connector 180, and the content of video stored in the recorded program storage module 160. The video reproducer 107 decodes (reproduces) the content thus acquired, and outputs it to the display controller 106.

The remote controller operation receiver 101 receives user's operation. More specifically, when a user operates an input device, the remote controller operation receiver 101 recognizes the operation and receives an input provided by the operation. Examples of the input device include the remote controller 90 provided with operation buttons, a keyboard (not illustrated), and a mouse (not illustrated). The user's operation may be pressing an operation button on the remote controller 90, typing on the keyboard, moving the mouse or pressing the mouse button, and the like. For example, when a user retrieves desired content as well as contents related to the desired content from a plurality of contents, the user selects content (key content) as a search key using the input device from a plurality of contents of the electronic program guide displayed on the display module 170. The remote controller operation receiver 101 receives this selection operation, i.e., specifies the content as a search key and receives an instruction to retrieve contents. The key content need not necessarily be specified based on the user selection, and may be specified by the system.

The key content may be content that is being reproduced. In this case, the user operates the input device while the content is being reproduced. Thus, the remote controller operation receiver 101 receives this operation to select the content being reproduced as a key content, i.e., an instruction to retrieve contents.

The remote controller operation receiver 101 also receives an instruction as to display information of content of current interest in list information indicating display information of a plurality of contents displayed on the display module 170. The details will be described later.

The metadata acquiring module 103 acquires, when the remote controller operation receiver 101 receives selection operation for key content, meta data of all contents (the key content and other contents than the key content). More specifically, for example, the metadata acquiring module 103 acquires the metadata of the contents from the recorded program storage module 160. The metadata acquiring module 103 may request the IPTV server 200 for the metadata of the contents and acquire the metadata. The metadata acquiring module 103 may also acquire the metadata of the contents from the electronic program guide stored in the EPG storage module 150.

The metadata retriever 102 retrieves, when the remote controller operation receiver 101 receives selection operation for the key content, metadata of the key content from the metadata of the contents acquired by the metadata acquiring module 103. The metadata retriever 102 then outputs the metadata of the key content to the correlation calculator 104. The metadata retriever 102 also retrieves, based on the metadata of the key content acquired by the metadata acquiring module 103, metadata of other contents to be the objects of calculation by the correlation calculator 104 as to the correlation with the metadata of the key content. The metadata retriever 102 then outputs the metadata of the other contents to the correlation calculator 104.

The metadata retriever 102 also outputs, when the remote controller operation receiver 101 receives selection operation for the key content, metadata of all the contents acquired by the metadata acquiring module 103 to the display information generator 105.

The correlation calculator 104 calculates the correlation between the key content and each of the other contents based on the metadata of the key content and the other contents received from the metadata retriever 102 and also the view correlation information acquired by the view information acquiring module 190 with respect to each item contained in the metadata. Examples of the items include title and channel. More specifically, the correlation calculator 104 calculates correlation RM using the following Equation 1:

correlation RM=AΣₙ₌₁^{N}faₙ(M11(n), M21(n))×waₙ (1)

where N represents the total number of metadata items acquirable by the metadata acquiring module 103, M11 represents the metadata of the key content, M21 represents the metadata of any of the other contents, and (n) represents n-th metadata acquired by the metadata acquiring module 103. Further, faₙ(M11(n), M21(n)) is a function that returns the correlation between metadata M11(n) and M21(n) as RMₙ, and Waₙ is a value (n=1, . . . , N) indicating weight.

As described above, although various types of information is acquired as the metadata, the metadata will be described below as including five items (N=5), i.e., recoding date and time, title of content, channel, genre, and cast, for simplicity. The five items of the metadata will be described as n=1, 2, . . . , 5 in the above order.

The correlation RM of the other contents with respect to the key content can be represented by the weighted linear sum of the following five correlations RM₁ to RM₅ weighted based on the view correlation information:

RM₁=fa₁ (recoding date and time of metadata M11, recoding date and time of metadata M21)

RM₂=fa₂ (title of metadata M11, title of metadata M21)

RM₃=fa₃ (channel of metadata M11, channel of metadata M21)

RM₄=fa₄ (genre of metadata M11, genre of metadata M21)

RM₅=fa₅ (cast of metadata M11, cast of metadata M21)

For example, fa₁ is a function that is larger for a smaller difference in recoding date and time between the metadata M11 and m21 and is smaller for a larger difference in the recoding date and time. More specifically, fa₁ may be represented by using a relational expression as follows:

MO1/|rec_data(M11)−rec_data(M21)|

where rec_data (x) is a function that uniquely converts recoding date and time of x into an integer, MO1 is an arbitrary constant number, and |X| is a function indicating the size of X and is typically an absolute value. Specifically, rec_data (x) is a function that converts the recoding date and time into an integer such as seconds having elapsed from a reference date and time determined as 0.

While an example is described above in which a function g represented as g(x)=MO1/|X| is applied to fa₁(M11, M21)=g(rec_data (M11)−rec_data (M21)), it is not so limited. The function g may be a function with L2 norm as, for example, g(x)=MO1/∥x∥. In this case, ∥x∥ is the square root of the sum of squares of the differences between elements that constitute x.

Other functions such as a sigmoid function and a gamma function may be applied to g(x). Besides, while an example is described above in which the function is larger as the recoding dates and times of the metadata M11 and M21 are closer, it is not so limited. The function may be smaller as the recoding dates and times of the metadata M11 and M21 are closer. Further, the function g may be large when a specific condition is satisfied.

For example, fa₂ is a function that is larger as more of the same letters or characters are contained in the character strings of the titles of the respective metadata M11 and M21. More specifically, if the title of the metadata M11 is “ABCDE” and that of the metadata M11 is “FGCDH”, two letters “CD” are contained in both the titles. If the title of the metadata M11 is “ABCDE” and that of the metadata M11 is “FGHIE”, one letter is contained in both the titles. Therefore, the value of fa₂ is larger in the former case. The correlation may be determined based on a keyword contained in the brief description (subtitle) of a program in the same manner as the title basis.

While an example is cited above in which the number of the same letters or characters contained in both the titles are simply compared, this is not intended as a limitation. Additional conditions may be used such as that the function is larger as more of the same letters or characters are contained in both the titles from the top, or that even if no same letter is present in both the titles, when the titles have a common idea, they are determined to be the same. As an example of the latter case, a Japanese word “yakyu” is regarded as the same as “baseball”, and the titles that contain the words “yakyu” and “baseball”, respectively, are determined to contain the same character string.

Besides, when the titles have the same main character string and different sub character strings, they are likely to be of contents of the same series. Accordingly, in such a case, the value of fa₂ may be set to large. Specifically, for example, “ABCDE #2” and “ABCDE #3” are likely to be the titles of different episodes of the same drama series. Therefore, in such a case, the value of fa₂ may be doubled. Note that the above is described by way of example only, and the comparison as described above may be accomplished with high accuracy by commonly known technologies such as approximate pattern matching and regular expression matching.

For example, fa₃ is a function that is large when the metadata M11 and M21 are of contents of the same channel. Simply, fa₃ may be a function that takes value MO2 when the metadata M11 and M21 are of contents of the same channel and otherwise takes value 0. The value MO2 is an arbitrary constant number. In addition, if the metadata M11 and M21 are of contents of affiliate channels, the value of fa₃ may be set to a different value. For example, fa₃ may be a function that returns value MO2/2 when the metadata M11 and M21 are of contents of affiliate channels. Further, fa₃ may be a function that returns value MO2/4 if the metadata M11 and M21 are of contents of affiliate channels but of different broadcast media. Note that the above is described by way of example only, and fa₃ may be an arbitrary function.

For example, fa₄ is a function that is large when the metadata M11 and M21 are of contents of the same genre. More specifically, fa₄ may be a function that takes value MO3 if the metadata M11 and M21 both belong to the same genre “sports” and otherwise takes value 0. In addition, if the metadata M21 belongs to the subgenre of the metadata M11 such as, for example, if the metadata M11 belongs to the genre “sports” and the metadata M21 belongs to the genre “baseball”, fa₄ may be a function that takes value MO3/2. Further, even if the metadata M11 and M21 do not directly belong to the same genre, when they can be categorized in the same genre such as, for example, when the metadata M11 belongs to the genre “baseball” while the metadata M21 belongs to the genre “football” and the both are categorized in sports, fa₄ may be a function that takes value MO3/4. Note that the above is described by way of example only, and fa₄ may be an arbitrary function.

For example, fa₅ is a similar function to fa₄. More specifically, if the metadata M11 is of the content featuring “WW, XX, YY” and the metadata M21 is of the content featuring “XX, YY, ZZ”, then the same two persons are casted for both the contents. In such a case, fa₅ may be a function that takes value 2×MO4 (MO4: an arbitrary constant number), and it may be a function that takes value 0 if there is no same person casted for both the contents. Besides, someone in the cast may be a member of a group. For example, if a person KK is a member of a group XX, and when the metadata M11 is of the content featuring “VV, WW, XX” and the metadata M21 is of the content featuring “KK, YY, ZZ”, the person KK is casted in the content of M11 as a member of the group XX and also is casted in the content of M21. In such a case, fa₅ may be a function that returns value MO4/2.

In a similar fashion, the correlation between groups or between people featured in the contents may be defined. For example, when the groups XX and YY belong to the same office, fa₅ may be a function that returns value MO4/4. In this case, the correlation between a person and a group or between a person, a group and an office may be defined in the metadata or may be obtained from an external server (information site).

While an example is described above in which the correlation is calculated not differentiating people in the cast list, this is not so limited. The correlation may further be weighted according to the order on the cast list. For example, the derived correlation is left as it is with respect to the first person on the cast list for the metadata M11, while it is weighted by ½ with respect to the second person and similarly is weighted by ⅓ with respect to the third person. The order on the cast list for the metadata M21 may also be taken into account in addition to that for the metadata M11. For example, if the second person on the cast list for the metadata M11 is the third person on the cast list for the metadata M21, the correlation may be weighted by ½ with respect to the second person for the metadata M11 and may further be weighted by ⅓ with respect to the third person for the metadata M21. That is, the correlation may be weighted by ½×⅓=⅙. Besides, the correlation may be weighted differently with respect to a star playing a leading role based on information on the cast or the like. For example, the derived correlation may be double-weighted with respect to the star.

In Equation 1, A represents the view correlation information acquired by the view information acquiring module 190. The correlation calculator 104 calculates the weighted linear sum of the five correlations RM₁ to RM₅ calculated as above, and further weights the linear sum by the view correlation information, thereby calculating the correlation RM.

That is, in the example of FIG. 2, the view correlation information of the content No. 5 indicates 10 with respect to the content No. 1, while the view correlation information of the content No. 6 indicates 5 with respect to the content No. 1. Accordingly, the content No. 5 is weighted double compared to the content No. 6. Thus, if the content No. 1 is a key content, the correlation of the content No. 5 with the key content is double the correlation of the content No. 6 with the key content.

The display information generator 105 generates display information representing the details of the key content and the other contents based on the metadata of the key content and that of the other contents output from the metadata retriever 102 and the view correlation information output from the view information acquiring module 190.

More specifically, for example, based on the metadata of video data of content stored in the recorded program storage module 160, the display information generator 105 adds such items as a title to the representative image of the video data to generate display information to be displayed on the display module 170. Further, for example, based on the metadata of video data of content obtained from the IPTV server 200, the display information generator 105 adds such items as a title to the representative image of the video data to generate display information to be displayed on the display module 170. Still further, for example, based on the electronic program guide stored in the EPG storage module 150, the display information generator 105 generates display information to be displayed on the display module 170 to indicate the title of a TV program, the broadcast date and time, the channel, the brief description of the TV program, and the like.

Besides, the display information generator 105 adds a mark to the display information to be displayed on the display module 170 to identify weight applied to the representative image of the video data based on the view correlation information received from the IPTV server.

The display information will now be described in detail. FIGS. 4A and 4B illustrate examples of the display information representing the details of content. FIG. 4A illustrates display information C1 of content generated based on, for example, the view correlation information and the metadata of video data stored in the recorded program storage module 160. As illustrated in FIG. 4A, the display information C1 includes a representative image C1-1 of the content and title “L358Δ*6” C1-2 of the content (video).

The display information C1 further includes a (recommendation) mark C1-6 identifying weight applied based on the view correlation information. Depending on the weight applied based on the view correlation information, different number of recommendation marks may be displayed or the recommendation mark may be displayed in different sizes. Further, information related to the view correlation information such as, for example, the number of users who have viewed key content and further viewed the content, in a form of a message.

On the other hand, FIG. 4B illustrates the display information C1 of content generated based on, for example, the view correlation information and the electronic program guide. As illustrated in FIG. 4B, the display information C1 includes the channel C1-3, title “Noon Comedy Show” with subtitle “Great line up of comedians invite you to enjoy a noon of hilarious entertainment” C1-4 of the content (video), and broadcast date and time C1-5. The display information C1 of FIG. 4B further includes, as with that of FIG. 4A, a (recommendation) mark C1-7 identifying weight applied based on the view correlation information.

As described above, the display information of content includes information related to the view correlation information. Thus, a user can easily acquire the view correlation information related to the content based on the preference of other users and the view correlation information managed by the IPTV server 200. This allows the user to have an easy access to content with high correlation.

The display controller 106 displays content output from the video reproducer 107 on the display module 170.

When the remote controller operation receiver 101 receives an instruction from a user to retrieve content, the display controller 106 displays list information indicating a list of the display information of key content and that of other contents related to the key content.

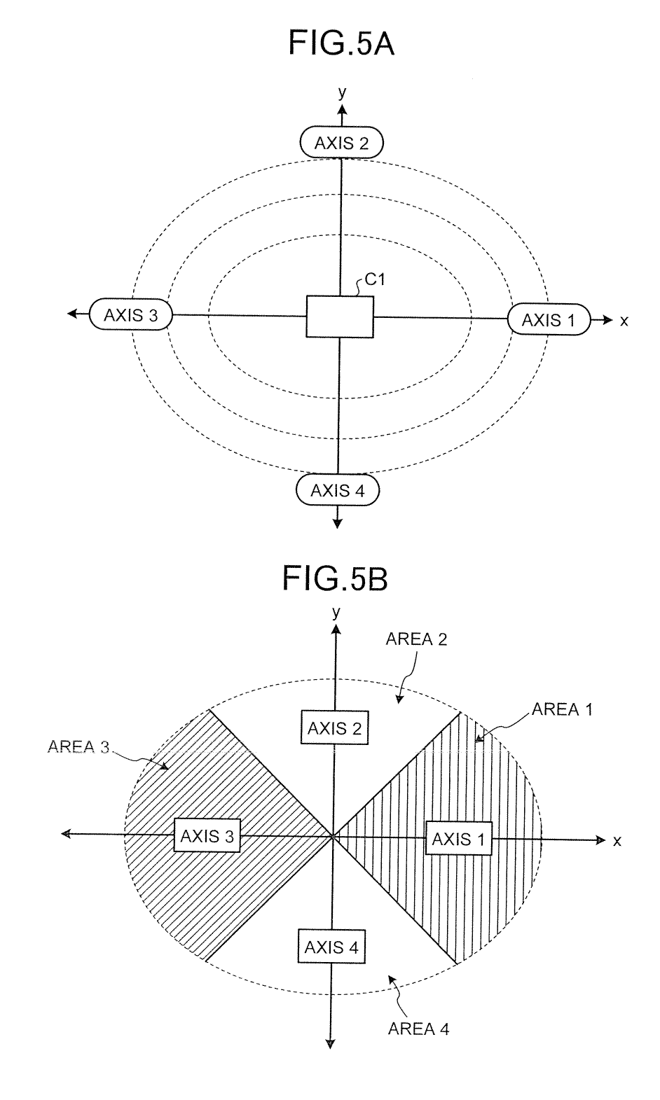

In the list information, the display information of the key content is arranged in a desired position. With the position of the display information of the key content as the center, pieces of the display information of the other contents are arranged to form concentric polygons, for example, correspondingly to the directions of operation on an operation button such as an arrow key on the remote controller 90. The display screen is divided into predetermined areas for respective items in radial directions from the center. The pieces of the display information of the other contents are arranged in the predetermined areas such that the one with higher correlation is closer to the center. Additionally, in the list information, the display information of the key content is displayed in the largest size, and the display information of the other contents is displayed smaller as the distance from the center increases. A description will be given of the operation of displaying the display information with reference to FIGS. 5A to 9. FIGS. 5A to 9 are schematic diagrams for explaining how to display the display information.

As illustrated in FIG. 5A, the display controller 106 arranges the display information C1 of the key content at a desired position. The display controller 106 then sets, using the position of the display information C1 as the center, four axes (axes 1 to 4) in the positive x-axis direction, the positive y-axis direction, the negative x-axis direction, and the negative y-axis direction, respectively. Thereafter, the display controller 106 assigns each item contained in the metadata of the selected key content to one of the four axes. Referring to FIG. 3, as items contained in the metadata, the “title” of a TV program (content), the “cast” of the TV program, a “keyword” for search contained in the brief description of the TV program, and the “genre” of the TV program are each assigned to one of the four axes. A user can use the items assigned to the axes as indices for searching for contents related to the key content.

As illustrated in FIG. 5B, the display controller 106 divides the display area into predetermined areas (areas 1 to 4) in radial directions from the display information C1 in the center. The display area is divided at an arbitrary angle, for example, an angle of 90°, such that each of the predetermined areas includes one of the axes assigned one of the items. In this manner, the display controller 106 generates the predetermined areas (area 1 to 4) each including one of the axes.

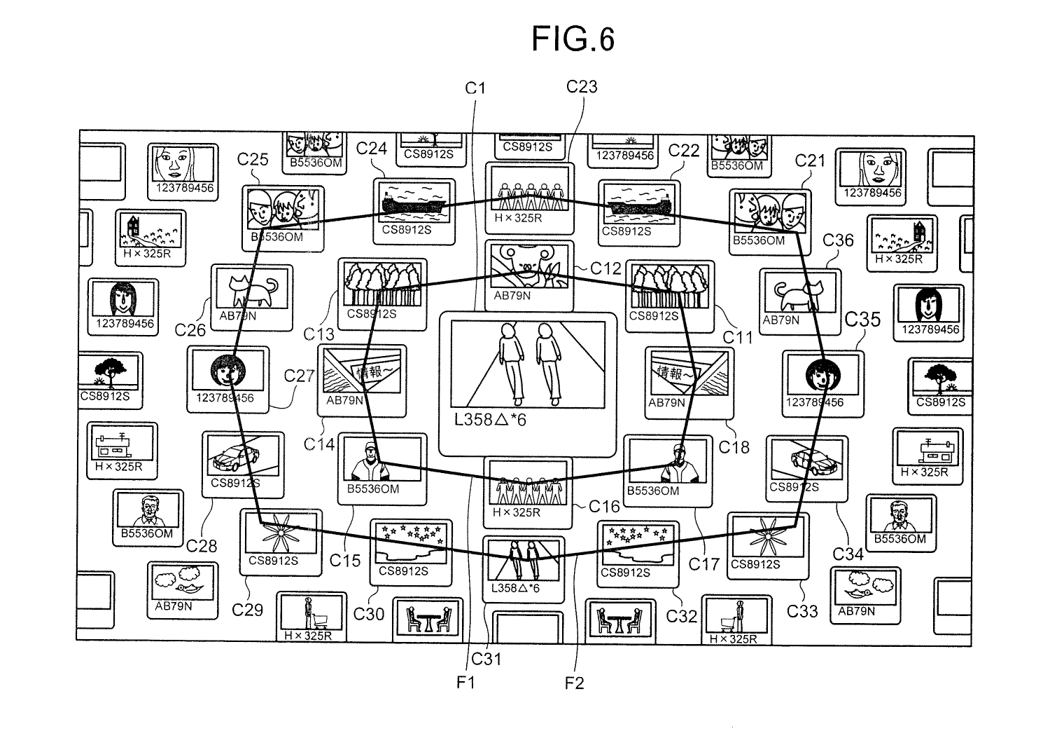

As illustrated in FIG. 6, the display controller 106 arranges pieces of display information of other contents on a plurality of octagons F1, F2, . . . , which are concentrically formed around the display information C1 of the key content as the center, correspondingly to up, down, left, and right directions of the operation button on the remote controller 90. More specifically, the display controller 106 arranges eight pieces of display information C11 to C18 of other contents on the corners of the octagon F1. Further, the display controller 106 arranges on the corners of the octagon F2 eight pieces of display information C21, C23, C25, C27, C29, C31, C33, and C35 of other contents, and also eight pieces of display information C22, C24, C26, C28, C30, C32, C34, and C36 of other contents between the respective pieces along the directions of the operation button. In the same manner as just described, the display controller 106 arranges on the corners of each octagon eight pieces of display information of other contents, and also eight pieces of display information of other contents between the respective pieces. With this arrangement of display information of other contents, with respect to any piece of display information, other pieces of display information are arranged along the up, down, left, or right directions of the operation button.

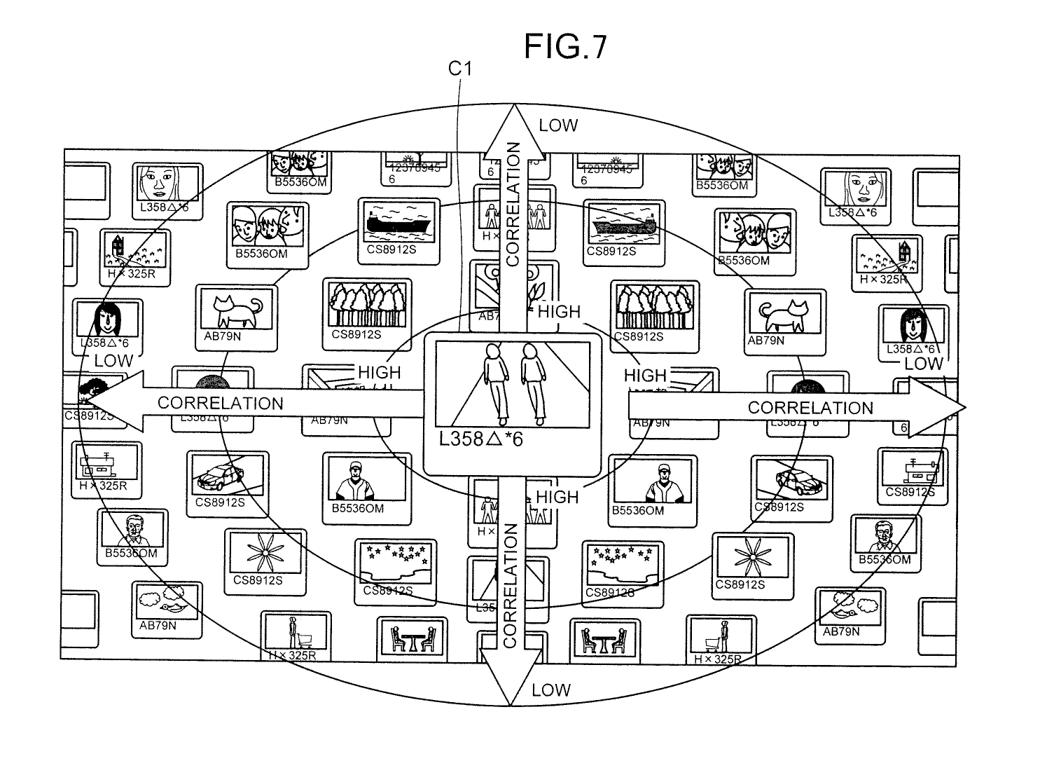

At this time, as illustrated in FIG. 7, the display controller 106 arranges pieces of display information of other contents with higher correlation with the key content closer to the center at which is arranged the display information C1 of the key content. In other words, pieces of display information of other contents with lower correlation with the key content are arranged more distant from the center. That is, in the example of FIG. 6, the display controller 106 arranges pieces of display information of other contents with the highest correlation with the key content on the octagon F1. The display controller 106 also arranges pieces of display information of other contents in descending order of correlation with the key content on the octagon F2, F3, and other octagons (not illustrated).

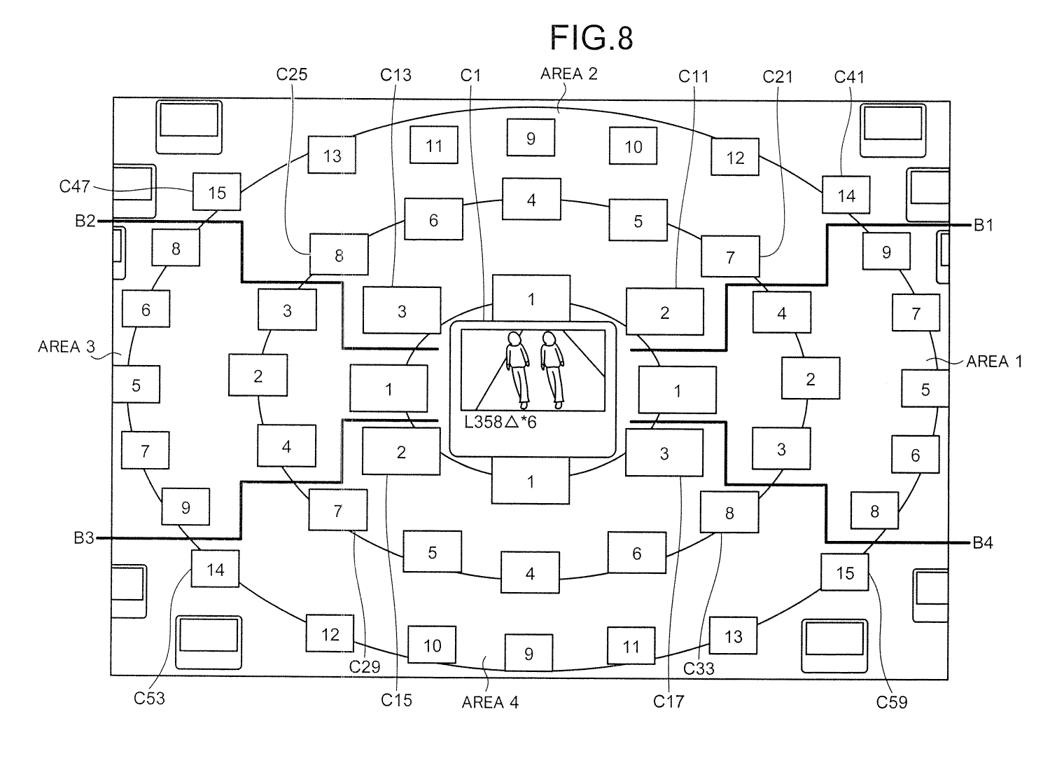

In addition, the display controller 106 arranges pieces of display information of other contents in descending order of correlation with the key content in each of the predetermined areas previously obtained for each item. More specifically, as illustrated in FIG. 8, for respective items assigned to the area 1 defined by boundary lines B1 and B4, the area 2 defined by boundary lines B1 and B2, the area 3 defined by boundary lines B2 and B3, and the area 4 defined by boundary lines B3 and B4, the display controller 106 arranges pieces of display information of other contents in the order of numbers assigned to the pieces. Thus, with respect to each of the items, the pieces of the display information of the other contents can be arranged from around the center in descending order of correlation with the key content.

In the example of FIG. 8, pieces of the display information C11, C21 and C41 are located in positions capable of belonging to both the areas 1 and 2. For example, the pieces of the display information C11, C21 and C41 may be set to belong to either one of the areas for items in which more contents having correlation with the key content higher than a predetermined threshold are present than in the other. In FIG. 8, since more other contents with correlation higher than the predetermined threshold are present in the area 2 than in the area 1, the pieces of the display information C11, C21 and C41 belong to the area 2. The same is applied to pieces of the display information C13, C25, C47, C15, C29, C53, C17, C33, and C59.

While an area to which display information displayed near a boundary line belongs is described above as being determined based on the degree of correlation with the key content, this is by way of example and not of limitation. For example, display information displayed near a boundary line may belong to an area having more contents related to the key content than the other.

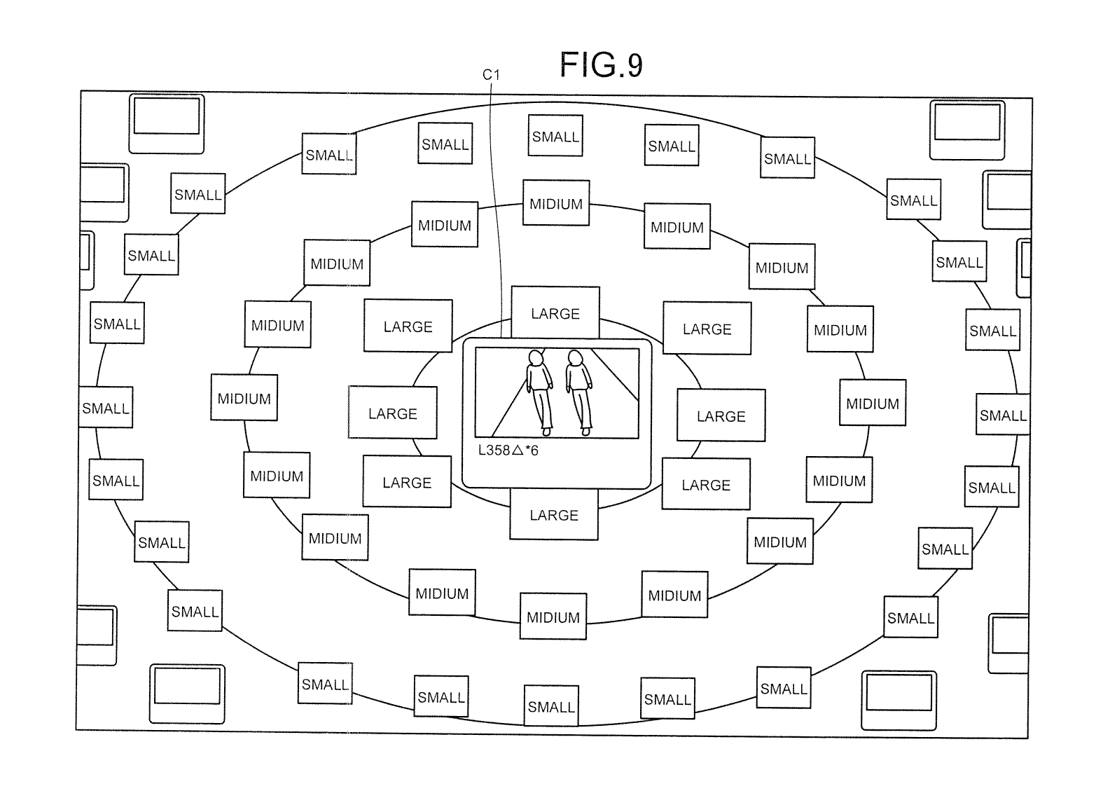

Further, as illustrated in FIG. 9, the display controller 106 displays the display information of the key content in the largest size, and the display information of the other contents smaller as the distance from the center increases.

When display information of another content than the key content belongs to a plurality of areas, the display controller 106 displays the display information in one of the areas so that the same display information is not displayed concurrently in the different areas. More specifically, when display information of the other content belongs to the areas 1 and 2, the display information is displayed in only one area assigned an item with respect to which the other content has higher correlation with the key content.

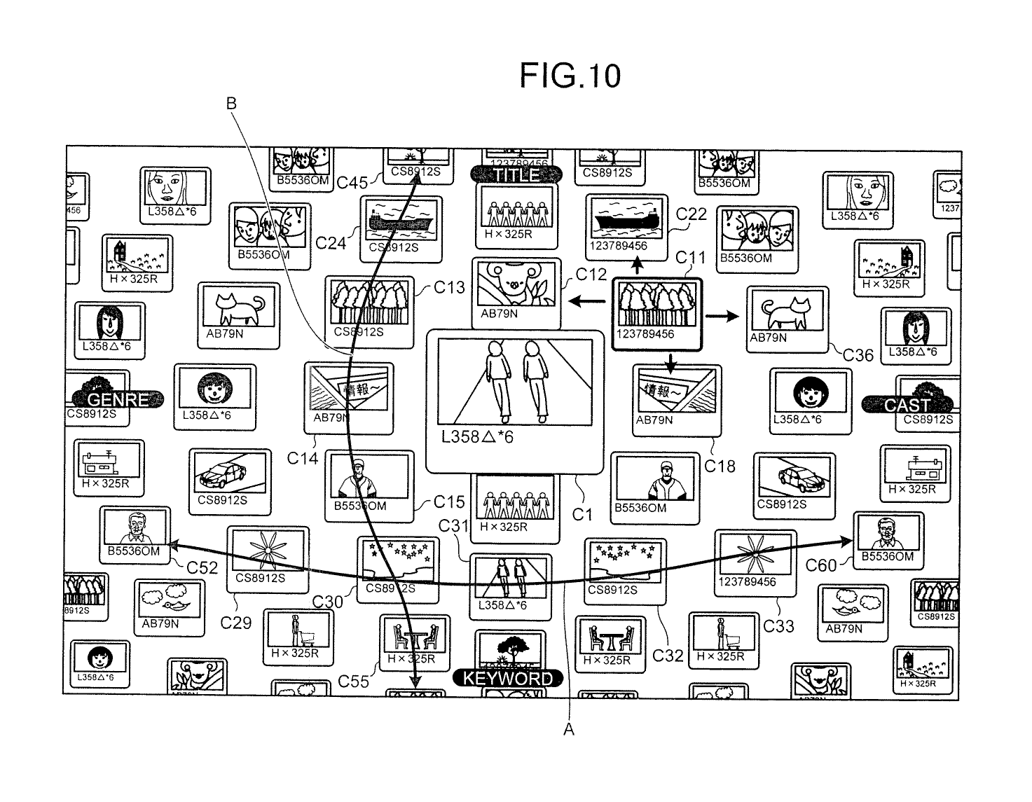

In this manner, the display controller 106 generates list information in which are arranged the display information C1 of the key content and the display information C11, . . . of the other contents, and displays the list information on the display module 170. Incidentally, the display controller 106 stores in advance the display position and size of the display information, and, after the calculation of the correlation with the key content, sequentially arranges pieces of the display information of the other contents each in a predetermined size. FIG. 10 illustrates an example of the list information in which are arranged the display information C1 of the key content and the display information C11, . . . of the other contents. In the list information of FIG. 10, items “Title”, “Cast”, “Keyword”, and “Genre” are displayed on the upside, right side, downside, and left side of the screen, respectively. Further, with the display information C1 of the key content as the center, pieces of the display information of the other contents are arranged from around the center toward the outside.

As described above, according to the embodiment, pieces of display information of other contents than key content are arranged along up, down, left, and right directions of an operation button. Therefore, in the example of FIG. 10, if the display information C30 is focused content for search, upon receipt of an instruction for left-right movement through the operation button on the remote controller 90 or the keyboard, the focus on the display information C30 moves in directions indicated by a double-head arrow A. Similarly, if the display information C30 is focused content for search, upon receipt of an instruction for up-down movement through the operation button, the focus on the display information C30 moves in directions indicated by a double-head arrow B. Additionally, for example, if the cursor moves one space to the right in response to an instruction when the focus is on the display information C11, the focus moves to the display information C36. Similarly, if the cursor moves one space in the up, left, or down direction in response to an instruction, the focus moves from the display information C11 to the display information C22, C12, or C18. Thus, the operation using the operation button such as an arrow key on the remote controller 90 or the keyboard can be facilitated.

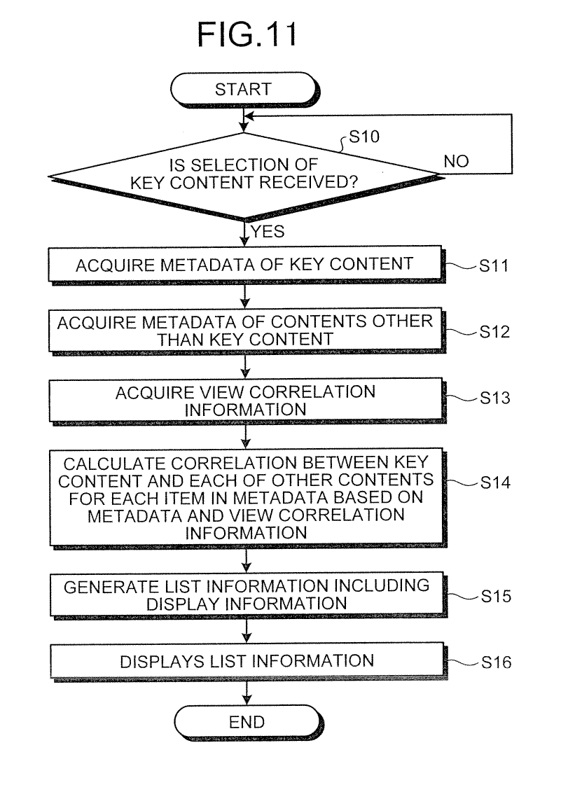

A description will now be given of the process of displaying display information performed by the display processing apparatus 100. FIG. 11 is a flowchart of the process of displaying the display information performed by the display processing apparatus 100.

The remote controller operation receiver 101 waits for receiving the selection of key content thorough the input device (S10). Upon receipt of the selection (Yes at S10), the metadata acquiring module 103 acquires metadata of the selected key content (S11). The metadata acquiring module 103 then acquires metadata of contents other than the key content (S12). The view information acquiring module 190 acquires the view correlation information (S13).

The correlation calculator 104 calculates the correlation between the key content and each of the other contents with respect to each item contained in the metadata, and weights the linear sum of correlations for the items based on the view correlation information to obtain the correlation (S14). The display controller 106 generates list information in which are arranged display information of the key content and display information of the other contents (S15). Pieces of the display information of the other contents are arranged according to their correlation with the key content. The display controller 106 displays the list information on the display module 170 (S16).

As described above, the list information is displayed in which are arranged display information of key content as a search key and that of other contents related to the key content. In the list information, with the position of the display information of the key content as the center, pieces of the display information of the other contents are arranged to form concentric polygons along the directions of operation with the operation button or the keyboard. Pieces of display information of other contents with higher correlation with the key content are arranged closer to the center. With this, by operating the remote controller 90, the keyboard, or the like, a user can easily retrieve content related to the key content from various types of contents.

As described above, according to the embodiment, the correlation with key content is calculated using the view correlation information that cannot be obtained from metadata. Thus, it is possible to easily retrieve contents related to the key content from various types of contents.

Moreover, according to the embodiment, differently from the items of metadata, the view correlation information is not used as one item in calculating the correlation, but used to weight the linear sum of correlations for each item of metadata. Thus, the view correlation information is not displayed as a single item axis. The view correlation information can be reflected over the entire display regardless of item axes. Thus, a user can easily recognize the display.

While the view correlation information is described above as being obtained from the view correlation between two different contents, this is by way of example and not of limitation. The view correlation information may be obtained from other view information corrected by the IPTV server 200, recommendation information related to contents distributed from the IPTV server 200, and the like.

The computer program may be executed on a computer to realize the same function as the display processing apparatus 100. The computer program may be provided to the computer as being stored in a computer-readable storage medium, such as a compact disc-read only memory (CD-ROM), a flexible disk (FD), a compact disc recordable (CD-R), and a digital versatile disc (DVD), as a file in an installable or executable format.

The computer program may be stored in a computer connected via a network such as the Internet so that it can be downloaded therefrom via the network. The computer program may also be provide or distributed via a network such as the Internet.

The computer program may be provided as being stored in advance in ROM or the like. The computer program comprises modules that implement the above constituent elements (the remote controller operation receiver 101, the metadata retriever 102, the metadata acquiring module 103, the view information acquiring module 190, the correlation calculator 104, the display information generator 105, the display controller 106, the video reproducer 107, and the broadcast receiver 108). As real hardware, the CPU loads the computer program from the storage medium as described above into the main memory and executes it. With this, the constituent elements, such as the remote controller operation receiver 101, the metadata retriever 102, the metadata acquiring module 103, the view information acquiring module 190, the correlation calculator 104, the display information generator 105, the display controller 106, the video reproducer 107, and the broadcast receiver 108, may be implemented on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display processing apparatus comprising:
an operation receiver configured to receive operation to select key content in a first type as a search key;
a view information acquiring module configured to acquire view correlation information indicating content view tendency;
a correlation calculator configured to calculate correlation of each of second contents with the key content based on similarity to the key content and the view correlation information, the second contents being of a plurality of types including a second type different from the first type;
a display information generator configured to generate first display information of the key content and second display information of the second contents; and
a display controller configured to display, on a display device, list information including the first display information at a predetermined position and pieces of the second display information around the predetermined position, the pieces of the second display information being arranged such that second display information of second content with higher correlation with the key content is closer to the first display information.

2. The display processing apparatus of claim 1, wherein the view information acquiring module is configured to acquire the view correlation information from a server connected via a network.

3. The display processing apparatus of claim 1, wherein the display information generator is configured to generate display information that contains information related to the view correlation information.

4. The display processing apparatus of claim 1, further comprising a metadata acquiring module configured to acquire metadata of the key content and metadata of the second contents, wherein
the correlation calculator is configured to calculate the correlation of each of the second contents with the key content based on the metadata of the key content and the metadata of the second contents with respect to respective items contained in the metadata, calculate a linear sum of the correlations of each of the second contents, and weight the linear sum based on the view correlation information to obtain the correlation.

5. The display processing apparatus of claim 1, wherein the view correlation information includes information on number of users who has viewed the key content and further viewed any of the second contents.

6. A display processing method applied to a display processing apparatus comprising a controller and a storage module, the display processing method performed by the controller comprising:
an operation receiver receiving operation to select key content in a first type as a search key;
a view information acquiring module acquiring view correlation information indicating content view tendency;
a correlation calculator calculating correlation of each of second contents with the key content based on similarity to the key content and the view correlation information, the second contents being of a plurality of types including a second type different from the first type;
a display information generator generating first display information of the key content and second display information of the second contents; and
a display controller displaying list information including the first display information at a predetermined position and pieces of the second display information around the predetermined position, the pieces of the second display information being arranged such that second display information of second content with higher correlation with the key content is closer to the first display information.

7. A computer program product comprising a computer usable medium having computer readable program codes embodied in the medium that, when executed, causes a computer to implement:
an operation receiver configured to receive operation select key content in a first type as a search key;
a view information acquiring module configured to acquire view correlation information indicating content view tendency;
a correlation calculator configured to calculate correlation of each of second contents with the key content based on similarity to the key content and the view correlation information, the second contents being of a plurality of types including a second type different from the first type;
a display information generator configured to generate first display information of the key content and second display information of the second contents; and
a display controller configured to display list information including the first display information at a predetermined position and pieces of the second display information around the predetermined position, the pieces of the second display information being arranged such that second display information of second content with higher correlation with the key content is closer to the first display information.
